(19) United States
(12) Patent Application Publication
(10) Pub. No.: US 2024/0295161 A1
(43) Pub. Date: Sep. 5, 2024

(54) METHOD OF INSULATING AN OBJECT

(71) Applicant: AUBIN LIMITED, Ellon, Aberdeenshire (GB)

(72) Inventors: Patrick Collins, Aberdeenshire (GB); Joseph Collins, Aberdeenshire (GB)

(21) Appl. No.: 18/573,105

(22) PCT Filed: Jun. 23, 2022
(86) PCT No.: PCT/GB2022/051601

§ 371 Date: Dec. 21, 2023

(30) Foreign Application Priority Data
Jun. 23, 2021 (GB) 2109034.5

(51) Int. Cl. E21B 36/00

(52) U.S. Cl. CPC E21B 36/003

(57) ABSTRACT

A method of insulating an object, such as a pipe for carrying crude oil or natural gas, includes providing an insulating fluid comprising a base fluid and a viscosifying agent, wherein the viscosifying agent comprises silicon dioxide. The base fluid is optionally a non-aqueous base fluid. The method further includes the steps of adding the insulating fluid to a container, and placing the object in the container. The object which is insulated can be located remotely or subsea.

The present invention relates to a method of insulating an object, in particular a pipe.

The requirement to insulate equipment to prevent heat loss is a common feature of many production systems in the oil and gas industry.

When oil and gas is produced, it emerges from the ground at elevated temperatures and pressures as produced fluids. If these produced fluids are allowed to cool in an uncontrolled manner they act to deposit unwanted residues such as waxes, asphaltenes and gas hydrates in the production system resulting in blockages, thereby impeding the flow of hydrocarbons in a pipeline.

When such blockages have been formed it can be difficult and dangerous to effect their subsequent removal through some remedial action. As a consequence it is generally preferred to prevent these blockages either by means of the addition of a chemical or more commonly, insulating the production system to reduce the rate of heat loss, thus maintaining the temperature of the produced fluids and preventing the formation of deposits.

A number of commercially available techniques exist to provide insulation. An insulating polypropylene coating or some other polymer can be applied to equipment. A typical product of this kind would be Thermotite™ from Brederoshaw of Houston, Texas. Such coatings are effective but need to be applied in a factory in a complex and time consuming process which can involve 12 to 15 separate processes.

Alternatively, moulds are fitted around the items to be insulated and liquid silicone polymer is cast around the items. The material is catalysed to undergo a polymerisation reaction which results in a solid material being formed. Once the polymerisation process is complete the moulds are removed. A typical material may be Contratherm™ from Advanced Insulation of Gloucester, United Kingdom. This may have the benefit that it does not need to be made in a factory however the polymerisation reaction can be slow (2 to 5 days is typical) and sensitive to external factors such as heat. In addition the silicones and most particularly the catalyst are very expensive.

In accordance with a first aspect of the present invention there is provided a method of insulating an object, the method comprising the steps of:
providing an insulating fluid comprising a base fluid and a viscosifying agent, the viscosifying agent comprising silicon dioxide;
adding the insulating fluid to a container; and
placing the object in the container.

The insulating fluid may be a paste. The method may include the step of allowing the insulating fluid to form a paste.

The method may include the step of heating the insulating fluid before adding the insulating fluid to the container and/or allowing the insulating fluid to cool to form the paste before placing the object in the container.

The step of placing the object in the container may include the insulating fluid or paste contacting the object.

The steps of the method may be in any order. The step of placing an object in a container may be before the step of adding the insulating fluid to the container.

The method may further include the step of inverting the container after the step of allowing the insulating fluid to form a paste. The step of placing the object in the container may then involve lowering the container over the object so that the insulating fluid or paste is in contact with the object.

The container may have one or more ports. When the step of adding the insulating fluid to the container is before the step of placing the object in the container, any excess insulating fluid may exit the container through the one or more ports when the object is placed in the container. This may have the advantage that the method of insulating is quicker and/or easier and may allow application subsea. The insulating material can be preloaded in the container and then fitted around the object to be insulated and secured. This may have the advantage of being faster and/or easier to apply the insulating material and/or may have the benefit that the insulating material can be retrofitted to the object.

The object may be located remotely and/or subsea. The object may be a pipe. The pipe may carry hydrocarbons, typically crude oil and/or natural gas. The object may be a steel catenary riser. The object may comprise a plurality of pipes or pipelines. The plurality of pipes or pipelines may be bundled together.

The steps of providing the insulating fluid; heating the insulating fluid; adding the insulating fluid to the container; and allowing the insulating fluid to cool to form the paste may be done on land. The step of inverting the container may be done on a ship and the step of lowering the container over the object so that the insulating fluid or paste is in contact with the object may be done in one or more of water, the sea, and subsea. The object may be located subsea and/or on the seabed.

It may be an advantage of the present invention that the viscosity provided by the viscosifying agent comprising silicon dioxide is due to a physical interaction between the silicon dioxide of the viscosifying agent and the base fluid and/or other components of the insulating fluid.

The physical interaction between the silicon dioxide of the viscosifying agent and the base fluid and/or other components of the insulating fluid typically means the insulating fluid is resistant to degradation and/or increases the number of suitable base fluids.

The container typically has a similar shape, may be a three-dimensional shape, as the object. The container can of course be any suitable shape so that the object may be placed in it. The container is normally rigid, but may also be flexible. The container is normally made from one or more of fibreglass, glass-reinforced plastic (GRP), polyethylene and High-density polyethylene (HDPE).

The space in the container may be referred to as an annular space. The container typically encloses the object. The container may have an inlet port for the addition of the insulating fluid to and/or into the space between the object and the container. The container normally holds the fluid against the object.

The insulating fluid is typically a non-Newtonian fluid. The insulating fluid may be a non-Newtonian pseudoplastic fluid. The insulating fluid is typically a thixotropic fluid.

The thixotropic fluid typically has a high and/or increased viscosity when stationary and/or static and a low and/or lower viscosity when moved and/or agitated.

Preferably, the insulating fluid is not a gel, nor does it form a gel. Preferably, the insulating fluid is not curable and does not undergo any cross-linking.

The viscosity of the insulating fluid typically varies depending on the shear applied. The viscosity of the insulating fluid is typically from 2,000 to 30,000 centipoise at a shear rate of 1.1 s⁻¹ and/or from 400 to 4,000 centipoise at a shear rate of 75.4 s⁻¹.

It may be an advantage of the present invention that the insulating fluid or paste has a sufficiently high viscosity when stationary and/or static such that is does not flow under ambient conditions and/or does not flow under subsea conditions. This may be a particular advantage if the insulating fluid is released into the sea and/or water because the insulating fluid does not spread and is therefore more easily confined and/or cleaned up.

The base fluid is typically non-aqueous. The non-aqueous base fluid normally is a hydrophobic fluid such as a hydrocarbon-containing fluid. The hydrocarbon-containing fluid may contain saturated or unsaturated hydrocarbons. The hydrophobic fluid may be an oil, such as an oil comprising one or more triglycerides. The hydrophobic oil may be a vegetable oil. The hydrophobic oil may be a mineral oil Alternatively, the non-aqueous base fluid may comprise a siloxane. The siloxane may be part of a silicone oil.

The oil is typically a liquid. The oil may be the majority component vol/vol or wt/wt of the base fluid.

The oil is preferably a low toxicity oil, such as a hydrocarbon, such as an saturated or unsaturated hydrocarbon. The oil may comprise one or more poly-alpha-olefins, alkyl esters and/or vegetable oil. The base fluid may have a very low toxicity to marine life, the aquatic toxicity for fish LC50 being greater than or equal to 1000 mg/l. The base fluid may be referred to as having a low and/or relatively low aromaticity. The base fluid may be a mineral oil based product such as SIPDRILL™.

The insulating fluid typically comprises from 40 to 70% vol/vol base fluid, optionally from 50 to 60% vol/vol base fluid.

The base fluid may have a relatively low viscosity, that is a viscosity of from 1 to 5 cSt at 40° C. The flash point of the base fluid may be from 75 to 125° C. The base fluid may have a relatively high flash point, that is a flash point of more than or equal to 90° C.

The density of the base fluid may be from 0.7 to 1.1/cc, typically 0.96 g/cc. The pour point of the base fluid may be from 10 to 48° C.

The insulating fluid may further comprise a wax. The wax normally has a melting point of from 25 to 85° C. The wax may be a branched chain hydrocarbon.

The wax may be a synthetic or naturally occurring wax. The wax may be a product of a Fischer-Tropsch process. The wax is typically an organic compound. The wax is typically a lipid. The wax may be one or more of a mineral wax, paraffin wax, petroleum wax, vegetable oil, palm oil, coconut oil, and bees wax. The wax may be an ester comprising one or more long-chain carboxylic acids and one or more long-chain alcohols.

The wax may comprise one or more straight chains of carbon atoms. The wax may comprise one or more branched chains of carbon atoms. The wax may comprise a mixture of straight and branched chains of carbon atoms. The one or more straight or branched chains may have from 20 to 80 carbon atoms, typically from 20 to 50 carbon atoms and normally from 22 to 50 carbon atoms.

The insulating fluid typically comprises from 10 to 30%, normally from 15 to 25% wt/wt of wax.

The viscosifying agent is any substance which increases the viscosity and/or changes the rheological profile of the insulating fluid. The viscosity of the insulating fluid comprising the viscosifying agent typically decreases with an increase in shear rate. The decrease in viscosity with an increase in shear rate may be referred to as shear thinning.

Typically when the insulating fluid is subjected to shear forces, for example when being pumped and/or transferred from one container to another, the viscosity of the insulating fluid reduces and the insulating fluid flows relatively freely. Typically, when the shear forces are removed, for example when the insulating fluid is in the space between the object and the container, the viscosity increases, helping to keep the insulating fluid a homogeneous mixture.

The viscosifying agent comprises silicon dioxide. The silicon dioxide may be referred to as silica. The viscosifying agent may be a hydrophobic silica. The silicon dioxide may be a fumed colloidal silica. The silica may be a finely dispersed silica. The silica may be treated with dimethyldichlorosilane. The viscosifying agent may be Reolosil DM-20S™. The silica may have a high, optionally a very high surface area. The high surface area is typically a surface area greater than 100 m²/g; the very high surface area is typically a surface area greater than 300 m²/g. The silica may be a powder. The silica may have hydrophobic wetting characteristics. The silica may be Cab-o-sil DM20S™ with a surface area of from 160 to 200 m²/g, in the insulating fluid at 6% w/w. The silica may be Cab-o-sil DM30S™ with a surface area of 230+/−20 m²/g, in the insulating fluid at 8% w/w.

The silicon dioxide may be Aerosil™ and/or Cab-O-Sil™.

The silicon dioxide typically provides the insulating fluid with high viscosity, that is the necessary viscosity, at elevated temperatures, that is when the object is warm or hot and therefore the insulating fluid is warm or hot.

The insulating fluid typically comprises from 3 to 10% vol/vol viscosifying agent, optionally from 5 to 8% vol/vol viscosifying agent.

The insulating fluid may optionally comprise antibacterial agents and/or corrosion inhibitors.

The insulating fluid may further comprise microspheres. The viscosifying agent may help to suspend microspheres in the insulating fluid.

The microspheres are normally mixed with the viscosifying agent and/or a mixture of the viscosifying agent and the base fluid. The mixture may be referred to as a viscosified base fluid. The mixture may also contain a dispersant.

In use one or more of the base fluid, microspheres, viscosifying agent, dispersant when present, and insulating fluid may be heated to at least 70° C. Heating one or more of the base fluid, microspheres, viscosifying agent, dispersant when present, and insulating fluid typically helps to make the insulating fluid a homogenous mixture of two or more of the base fluid, microspheres, viscosifying agent and dispersant.

The insulating fluid comprising the viscosifying agent is typically a stable mixture in the temperature range of from −10 to 100° C., typically from 0 to 70° C. It may be an advantage of the present invention that the insulating fluid is typically a stable mixture. The insulating fluid is a stable mixture when the components of the insulating fluid do not separate or split from one another over time and/or with an increase in temperature.

The microspheres may be from 1 μm to 5 mm in diameter, optionally from 5 to 500 μm in diameter and typically from 20 to 200 μm in diameter.

The microspheres are typically rigid and so are incompressible at underwater pressures. The microspheres may be obtained from 3M™. The microspheres may be rated to over 2,000 kPa (300 psi), normally over 31,000 kPa (4500 psi), preferably over 41,000 kPa (6000 psi) and optionally over 55,000 kPA (8000 psi). Other microspheres with different strengths and densities may be used and generally stronger microspheres have higher densities. The higher the rating of the microspheres, the deeper the water and/or deeper in the water that they can be used in.

The microspheres may be glass microspheres. The glass microspheres may be hollow and may contain sealed gas. The microspheres may lower the density of the insulating fluid to a density of approximately 530 kg/m³ at room temperature.

The insulating fluid typically comprises from 25 to 60% vol/vol microspheres, optionally from 30 to 50% vol/vol microspheres and typically less than 55% vol/vol microspheres.

The thermal conductivity of the insulating fluid is normally from 0.08 to 0.1 W/m K.

The insulating fluid and container may be referred to as a composite system or material. The insulating fluid may provide thermal insulating properties and the container may provide a physical barrier to water, mitigating water ingress.

After the step of adding the insulating fluid to the space between the object and the container, the insulating fluid typically cools and the viscosity of the insulating fluid increases. The insulating fluid may cool below the wax appearance temperature. The cooled insulating fluid is typically a paste and/or a thick or very thick paste. In an alternative embodiment, the insulating fluid may be heated by the object to be insulated.

When the insulating fluid changes from a liquid to paste, the paste that forms is not the result of a curing/reactive process to form new bonds (e.g. addition of a hydrosiloxane to a vinyl bond), but from a physical melting and “unmelting” of the wax whereby previously undissolved wax particles are now fully mixed with the base oil after such a process.

The step of adding the insulating fluid to the space between the object and the container may include pumping the insulating fluid.

When the insulating fluid comprises a wax, the step of heating the insulating fluid typically melts the wax. It may be an advantage of the present invention that the insulating fluid can be removed from the container by heating the insulating fluid and thereby melting the wax. The insulating fluid can therefore be one or more of recycled, reused or disposed of appropriately.

An embodiment of the invention will now be described by way of example only and with reference to the accompanying drawings, in which:

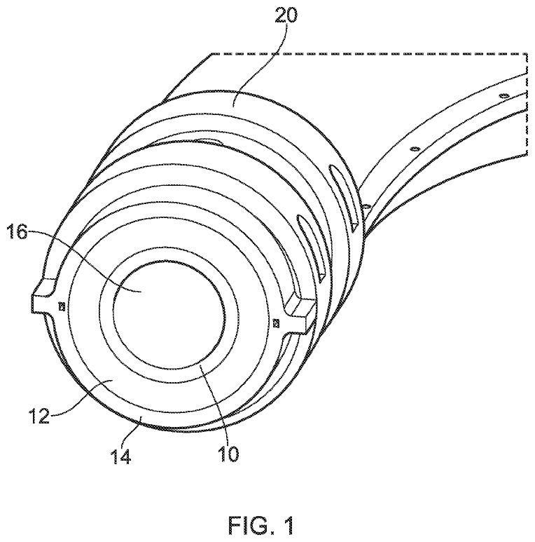

FIG. 1 is cross-sectional view of an object, container and insulating fluid according to an embodiment of the present invention;

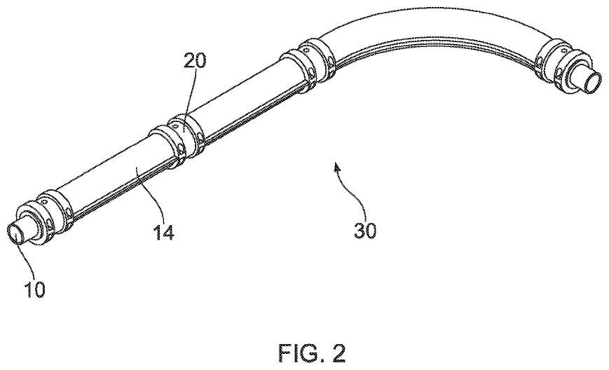

FIG. 2 is a perspective view of an object and a container;

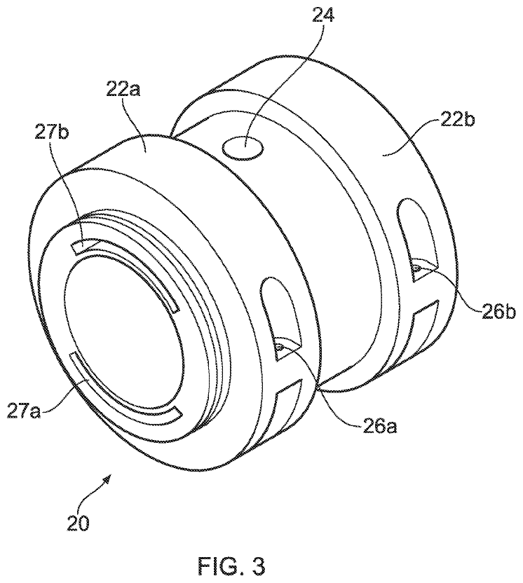

FIG. 3 is a perspective view of a connector for attaching together two containers;

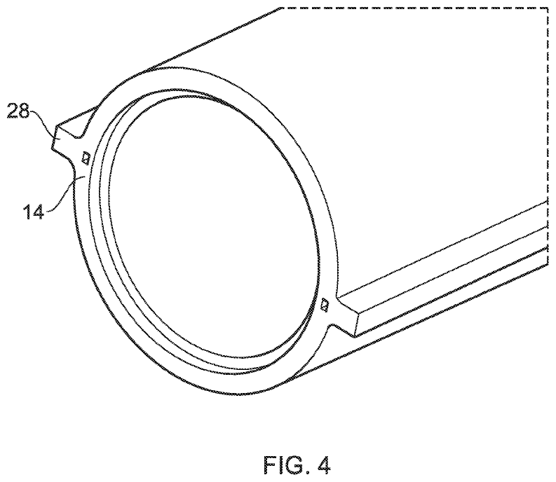

FIG. 4 is a perspective view of a container; and

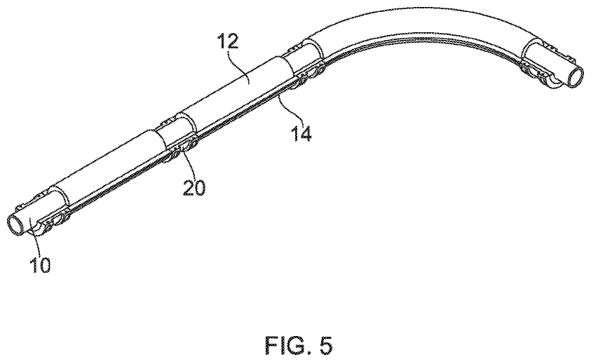

FIG. 5 is cross-sectional perspective view of an object, container and insulating fluid.

FIG. 1 shows an object 10, an insulating fluid 12 in the form of a paste and a container 14. The object 10 is a pipe with a bore 16. FIG. 1 also shows a connector 20.

The container 14 is made of high density polyethylene (HDPE). In an alternative embodiment the container 14 is made of polypropylene or polytetrafluoroethylene (PTFE). Other similar materials may be used.

The insulating fluid 12 comprises a base fluid and a viscosifying agent, the viscosifying agent containing silicon dioxide. The insulating fluid 12 shown in FIG. 1 occupies a space (not shown) between the pipe 10 and the container 14.

TABLE 1
shows typical viscosities of the insulating fluid (I/F)
at various shear rates. The viscosities were
measured on a Chandler 35 viscometer.

| Shear rate (s⁻¹) | | | Viscosity (cP) | | |
|---|---|---|---|---|---|
| | I/F V | I/F VW | I/F Si | I/F SiW | I/F LAW |
| 1.1 | | 7125 | 2672 | 6235 | 22712 |
| 2.3 | 3117 | 4231 | 1781 | 3563 | 16143 |
| 3.8 | 2138 | 2939 | 1336 | 2672 | 12692 |
| 7.5 | 1336 | 2138 | 935 | 1937 | 9152 |
| 11.3 | 1158 | 1737 | 802 | 1603 | 7704 |
| 22.6 | 802 | 1247 | 646 | 1225 | 5734 |
| 37.7 | 601 | 1109 | 534 | 1069 | 4696 |
| 75.4 | 494 | 1015 | 448 | 762 | 3497 |
| 113.2 | 454 | 1002 | 419 | 926 | |
| 226.3 | 423 | 779 | 401 | 853 | |

I/F stands for Insulating Fluid; V stands for vegetable oil; VW stands for vegetable oil with wax; Si stands for silicone oil; SiW stands for silicone oil with wax; and LAW stands for linear alkane with wax.

TABLE 2
shows thermal conductivity of the insulating fluid (I/F).

| | I/F | I/F | I/F | I/F | I/F | I/F | I/F |
|---|---|---|---|---|---|---|---|
| Fluid | V | VW | Si | SiW | LAW | LAMS | LAWMS |
| Thermal | 0.159 | 0.168 | 0.138 | 0.155 | 0.163 | 0.097 | 0.088 |
| conductivity | | | | | | | |
| (W/mK) | | | | | | | |

I/F stands for Insulating Fluid; V stands for vegetable oil; VW stands for vegetable oil with wax; Si stands for silicone oil; SiW stands for silicone oil with wax; LAW stands for linear alkane with wax; LAMS stands for linear alkane with microspheres; and LAWMS stands for linear alkane with wax and microspheres.

FIG. 2 shows the pipe 10, container 14 and connector 20. The method of insulating the pipe 10 includes installing the container 20 around the pipe 10 and adding the insulating fluid (not shown) to the space (not shown) between the pipe 10 and the container 20.

The system or series of containers 14 and connectors 20 is referred to as an assembly 30.

FIG. 3 shows the connector 20 for attaching together two containers (not shown). The connector 20 has two shoulders 22a & 22b that fit around the pipe (not shown). Each shoulder 22a & 22b receives an end of a container 14.

The shoulders 22a & 22b have holes 26a & 26b for bolts (not shown) that are passed through the holes 26a & 26b and into threaded holes (not shown) in the ends of the containers 14, to secure each end of a container to a connector 20.

The connector 20 has a port 24. The insulating fluid (not shown) is pumped into the annular space (not shown) via port 24 or a similar port (not shown) on the opposite side of the connector. The connector 20 also has ports 27a & 27b that allow insulating fluid (not shown) to flow out of the connector 20 and into the annular space (not shown) between the pipe and the container.

Some of the connectors 20 do not have the ports 27a & 27b and thereby allow sections of the system or series of containers and connectors (see FIG. 2) to be isolated or terminated.

FIG. 4 shows a container 14. The container 14 has lugs 28 that fit into sockets (not shown) in a connector 20. The threaded holes (not shown) in the end of the container 14, used to secure each end of a container to a connector 20, are in the lugs 28.

FIG. 5 shows the pipe 10, container 14, insulating fluid 12 and connector 20.

Generally, once the assembly 30 has been made-up, the insulating fluid 12 is pumped into the annular space (not shown) via a port (not shown) at the base of the assembly, filling the assembly until the fluid exits from the port 24 at the top of the assembly, indicating that the assembly is filled. The ports are then sealed and the pipe 10 has been insulated. The degree of insulation achieved will be directly related to the width of the annular space and therefore width and/or volume of insulating fluid. Because it uses prefabricated assembled components and the insulation, that is the insulating fluid, is pumped into place, the insulation can be installed quickly and efficiently and with reduced environmental risk.

Modifications and improvements can be incorporated herein without departing from the scope of the invention.

1. A method of insulating an object, the method comprising the steps of:
providing an insulating fluid comprising a base fluid and a viscosifying agent, the viscosifying agent comprising silicon dioxide;
adding the insulating fluid to a container; and
placing the object in the container.

2. A method according to claim 1, further including the step of the insulating fluid forming a paste.

3. A method according to claim 1, further including heating the insulating fluid before adding the insulating fluid to the container; and allowing the insulating fluid to cool to form a paste before placing the object in the container.

4. A method according to claim 1, wherein the insulating fluid further comprises a wax.

5. A method according to claim 4, wherein the wax has a melting point of from 25 to 85° C.

6. A method according to claim 4, wherein the insulating fluid comprises from 10 to 30% wt/wt of wax.

7. A method according to claim 4, further including heating the insulating fluid to melt the wax and, after the step of adding the insulating fluid to the container, allowing the insulating fluid to cool to form a paste.

8. A method according to claim 1, wherein the step of placing an object in a container is before the step of adding the insulating fluid to the container.

9. A method according to claim 3, further including the step of inverting the container after the step of allowing the insulating fluid to cool to form a paste, the step of placing the object in the container involving lowering the container over the object so that the insulating fluid is in contact with the object.

10. A method according to claim 1, wherein the object is located remotely or subsea, the object being a pipe for carrying crude oil or natural gas.

11. A method according to claim 1, wherein the container has a three-dimensional shape corresponding to a shape of the object.

12. A method according to claim 1, wherein the insulating fluid is a non-Newtonian fluid.

13. A method according to claim 1, wherein the insulating fluid is a thixotropic fluid.

14. A method according to claim 1, wherein the viscosity of the insulating fluid is from 2,000 to 10,000 centipoise at a shear rate of 1.1 s⁻¹ or from 400 to 1,500 centipoise at a shear rate of 75.4 s⁻¹.

15. A method according to claim 1, wherein the base fluid is non-aqueous and comprises an oil.

16. A method according to claim 1, wherein the base fluid is non-aqueous and comprises a siloxane.

17. A method according to claim 1, wherein the insulating fluid comprises from 40 to 70% vol/vol base fluid.

18. A method according to claim 1, wherein the density of the base fluid is from 0.7 to 1.5 g/cc.

19. (canceled)

20. A method according to claim 1, wherein the insulating fluid comprises from 3 to 10% vol/vol viscosifying agent.

21. A method according to claim 1, wherein the insulating fluid is a stable mixture in the temperature range of from −10 to 100° C.

22. A method according to claim 1, wherein the insulating fluid further comprise microspheres.

23. (canceled)

24. A method according to claim 22, wherein the insulating fluid comprises from 25 to 60% vol/vol microspheres.

25. A method according to claim 1, wherein the thermal conductivity of the insulating fluid is from 0.08 to 0.1 W/m K.
